(19) United States
(12) Patent Application Publication
(10) Pub. No.: US 2005/0224186 A1
(43) Pub. Date: Oct. 13, 2005

(54) Method for processing electrical parts, particularly for processing semiconductor chips and electrical components, and device for carrying out said method

(76) Inventor: Georg Rudolf Sillner, Zeitlarn (DE)

Correspondence Address: Hoffman Wasson & Gitler, 2461 South Clark Street, Suite 522 - Crystal Center 2, Arlington, VA, 22202, US

(21) Appl. No.: 10/512,086

(22) PCT Filed: Apr. 9, 2003
(86) PCT No.: PCT/DE03/01152

§ 371 Date: Nov. 8, 2004

(30) Foreign Application Priority Data
May 17, 2002 (DE) 102 22 620.2

(51) Int. Cl. B32B 1/00; B32B 35/00

(52) U.S. Cl. 156/584; 414/416.01; 438/464

(57) ABSTRACT

The invention relates to a novel method for processing electrical parts, particularly for processing semiconductor chips and electrical components, and a device for carrying out the inventive method.

### BACKGROUND OF THE INVENTION

The invention relates to a method for processing electrical parts.

A method is known in the art for the multiple manufacture of semiconductor chips, i.e. on a semiconductor wafer, which then for further processing is releasably fastened to a carrier, i.e. to a carrier foil (blue foil) clamped in a carrier frame. Afterwards, the wafer is separated into the individual semiconductor chips in such a manner that these chips still adhere to the carrier foil.

The further processing of the semiconductor chips takes place according to the state of the art, for example in so-called die bonders, in such a manner that these chips are picked up individually from the carrier foil by a pick-up element and then placed on a “second” carrier, which for example is formed by a lead frame or a substrate present in this lead frame. For the pick-up element, movement strokes in at least two axis directions are necessary, namely a transport stroke in horizontal direction between the semiconductor wafer and the second carrier and, both at the beginning and end of this transport stroke respectively, a vertical stroke for grasping and picking up a semiconductor chip from the carrier foil or for placing the respective semiconductor chip on the second carrier.

The processing of one semiconductor wafer, i.e. the transfer of the semiconductor chips present there in a plurality of rows to the second carrier at a high capacity (the number of transferred semiconductor chips per unit of time) is possible according to the prior art only by means of very fast movements of the pick-up element, particularly also considering the relatively long transport stroke, whereby for reasons of mass acceleration alone there is a limit to the increase in capacity that is possible by increasing the working speed.

The object of the present invention is to present a method and a device which enables the processing of electrical components held releasably on a carrier foil at a significantly higher capacity.

### SUMMARY OF THE INVENTION

“Electrical components” according to the invention are particularly semiconductor chips, which are held releasably and by separation of a semiconductor wafer on a carrier foil (blue foil) fastened in a carrier frame, hereby forming an array on the carrier foil that corresponds to the array of the chips in the wafer, namely in a plurality of rows that are parallel to each other and extend in one axis direction.

“Components” according to the invention are furthermore electrical components, particularly also such components that consist of a semiconductor chip with a housing produced by extrusion, for example a plastic housing and, for example, likewise are manufactured multiply using a common semiconductor wafer and are separated into the individual components after being placed on the carrier foil.

“Processing” according to the invention means in the simplest sense the transfer of the electrical components from the carrier foil to the second carrier in a pick-and-place operation using a pick-up element, which moves between the carrier foil and the second carrier for this purpose.

“Second carrier” according to the invention is for example the transport surface of a suitable transport element or also any other suitable carrier on which the components are placed.

“Processing of the first rows” according to the invention means that the electrical components or the groups of components are removed from the individual rows formed on the carrier foil, preferably such that in the following processing steps or strokes, the components of a new, first row are not transferred until the components of preceding rows have already been transferred completely to the second carrier.

The special feature of the method according to the invention consists in the fact that in each work stroke several components are removed simultaneously as a group directly from the carrier foil, preferably controlled by an electronic control device, so that the components on the second carrier form at least one second row, in which the components then preferably follow each other at regular intervals.

### BRIEF DESCRIPTION OF THE DRAWINGS

The invention is described below in detail based on exemplary embodiments with reference to the drawings, where:

FIG. 1 shows a simplified representation in top view of a carrier frame with a carrier foil and with a plurality of components in the form of semiconductor chips arranged on this carrier foil and the semiconductor chips picked up from the carrier foil by means of a pick-up unit and placed in a plurality of rows on a transporter;

FIG. 2 shows a simplified representation in vertical section of the pick-up unit and the ram unit of a work station for carrying out the method of FIG. 1, i.e. for picking up a group of a plurality of semiconductor chips from the carrier foil (blue foil) and for placing this group onto the transport element;

FIG. 3 shows a vertical section of the work station of FIG. 2 in a sectional plane extending perpendicular to FIG. 2;

FIG. 4 shows a component drawing of the pick-up head of the pick-up unit of FIGS. 2 and 3;

FIG. 5 shows a simplified representation similar to FIG. 2 of a further possible embodiment of the invention;

FIG. 6 and 7 show representations similar to FIGS. 2 and 3 of a further possible embodiment of the invention with a modified ram element as compared with that of FIGS. 2 and 3; and

FIG. 8 shows a simplified perspective functional view of a work station similar to FIGS. 2 and 3, together with the transport element connected to the work station and a further transporter or transport element connected to the first transport element by means of a flipping station.

### DETAILED DESCRIPTION OF THE INVENTION

In the drawings, 1 designates a semiconductor wafer, which is separated into a plurality of semiconductor chips 2 (integrated circuits or components) and arranged on a carrier foil 3, which in turn is held in a carrier frame 4.

By tensioning the carrier foil 3 at its peripheral area held in the carrier frame 4, the semiconductor chips 2 are at a distance from each other, but form an array on the carrier foil 3 in which the semiconductor chips 2 are arranged in several rows R1-Rn and in several columns, corresponding to the original circular disk form of the wafer 1 so that the rows R1-Rn and the columns extending perpendicular to these rows each have different lengths, namely in the manner that the length of the columns and rows increases toward the center of the wafer 1 and the chip array.

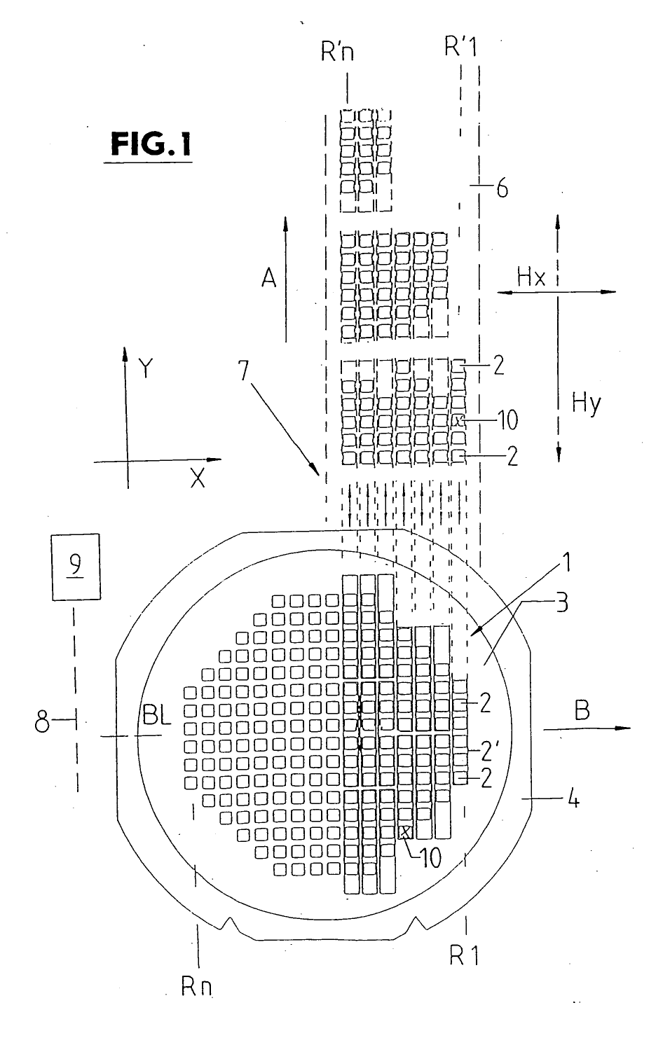

By means of a pick-up unit not depicted in FIG. 1 but generally designated 5, 5a, 5b in the subsequent drawings, the semiconductor chips 2 are picked up from the carrier foil 3 and placed on a transporter generally designated 6 in FIG. 1, which is suitable for transporting semiconductor chips and can have a wide variety of designs for this purpose, for example on a transporter, which is formed by a self-adhesive belt-like foil or from a transport belt, on which the semiconductor chips 2 are held by a vacuum, etc. The pick-up unit 5, 5a or 5b is part of a work station 7. By means of the transport element 6, the semiconductor chips 2 are transported away from this work station or from the carrier frame 4 with the carrier foil 3 and fed to a further application, as indicated by arrow A.

For the sake of simplification and better clarity, three spatial axes that extend perpendicular to each other are indicated in the drawings, namely the X-axis, the Y-axis and the Z-axis, of which the X-axis and Y-axis are horizontal axes that define the horizontal X-Y plane, while the Z-axis is the vertical axis.

The carrier foil 3 and thus also the wafer 1 arranged on this carrier foil are located in the horizontal X-Y plane.

The transport plane of the transport element 6, on which the semiconductor chips 2 are arranged, is likewise the horizontal X-Y plane. The transport direction A of the transport element 6 extends parallel to the Y-axis in the depicted embodiment.

The semiconductor chips 2 are placed on the transport element 6 or on the transport plane located there so that they form several—i.e. in the depicted embodiment a total of seven—rows of semiconductor chips 2 extending parallel to the transport direction A and parallel to each other, preferably closed rows, whereby each semiconductor chip 2 in a row perpendicular to the transport direction, i.e. in the X-axis, is next to a semiconductor chip 2 of an adjacent row, i.e. the semiconductor chips 2 are arranged on the transport element 6 in columns extending in the direction of the X-axis with seven semiconductor chips 2 each. The special feature of the work station 7 or of the method carried out by this station consists, firstly, in that the semiconductor chips 2 are transferred from the wafer 1 to the transport element 6 over a short path, and secondly, in that this transfer takes place so that several semiconductor chips 2 are removed from the carrier foil 3 in a row R1-Rn as a group and placed on the transport element 6 in one step, for which the pick-up element 5, 5a, 5b executes at least one back-and-forth motion in the direction of the Y-axis (horizontal stroke Hy) and one vertical stroke (Vz) in the Z-axis for removing the group of semiconductor chips 2 from the carrier foil 3 at the one end of the horizontal stroke Hy, and one vertical stroke (V′z) in the Z-axis for placing the group of semiconductor chips 2 on the transport element 6. The horizontal stroke Hy is thereby parallel to the transport direction A. In the depicted embodiment, six semiconductor chips 2 are picked up from the carrier foil 3 and then placed on the transport element 6 in each working stroke of the pick-up element 5.

The work station 7 comprises for example a holder 8, in which the carrier frame 4 is located and with which this carrier frame is aligned so that the rows R1-Rn do not extend in the Y-axis and the corresponding columns in the X-axis, and also that each row R′1-R′n formed on the transport element 6 has a congruent axis with a row R1-Rn on the carrier foil 3. The alignment of the carrier frame 4 and thus of the wafer 1 is effected by means of a camera system and an electronic unit 9 comprising an image processor. The camera system of the electronic unit 9 measures the configuration of the wafer 1 or the array of the semiconductor chips 2 on the carrier foil 3. The camera system also measures those semiconductor chips or their position, which is saved in the memory of the electronic unit 9, determined in a preceding test of the wafer 1 to be not usable and marked accordingly with a marking 10.

The movement of the pick-up unit 5 is controlled by means of the electronic control unit 9 so that the groups 2′ of semiconductor chips 2 placed on the transport element 6 form the respective closed rows R′1-R′n. In the embodiment depicted in FIGS. 1-3, the pick-up unit 5 is designed so that only semiconductor chips 2 of a particular row R1-Rn are picked up from the carrier foil 3 by this pick-up unit. In order to form several rows R′1-R′n on the transport element 6, which continuously moves by strokes in transport direction A, the pick-up unit 5 is designed so that in addition to the horizontal stroke Hy in transport direction A, it can also execute a horizontal stroke Hx crosswise to the transport direction. The marked, defective semiconductor chips 2 in the depicted method are likewise placed on the transport element 6 and not removed until a later process step, initiated by the electronic control unit 9, in the memory of which the position of the marked, defective semiconductor chips on the transport element 6 is stored.

In order to form the rows R′1-R′n on the transport element 6 in which (rows) the semiconductor chips 2 adjoin closely despite the different length of the rows R′1-R′n, at least the horizontal stroke Hy has a different length, controlled by the electronic control unit 9, i.e. the beginning and the end of this stroke Hy upon picking up the group 2′ from the carrier foil 3 and upon placing the respective group 2′ on the transport element 6 are controlled by the electronic control unit 9, taking into account the form of the wafer and the array of the semiconductor chips 2 on the carrier foil 3, resulting in the continuous rows R′1-R′n. The control program of the electronic control unit 9 is, for example, designed so that upon processing of the individual rows R1-Rn, the maximum possible number of semiconductor chips 2 is taken from the carrier foil 3 and placed on the transport element 6 in each stroke, followed in a subsequent stroke by the remaining semiconductor chips of the respective rows R1-Rn.

In the depicted embodiment, the holder 8 can furthermore be moved in the X-axis for processing of the individual rows R1-Rn.

The controlled, different length of the stroke Hy takes into account on the one hand that in the work station 7 for processing the rows R1-Rn a forward feed B is provided for the carrier frame 4 only in the X-axis and that the rows R1-Rn have differing lengths, so that during both the pick-up and placement of the semiconductor chips or the groups 2′, the pick-up element in any case must move to different positions in the Y-axis.

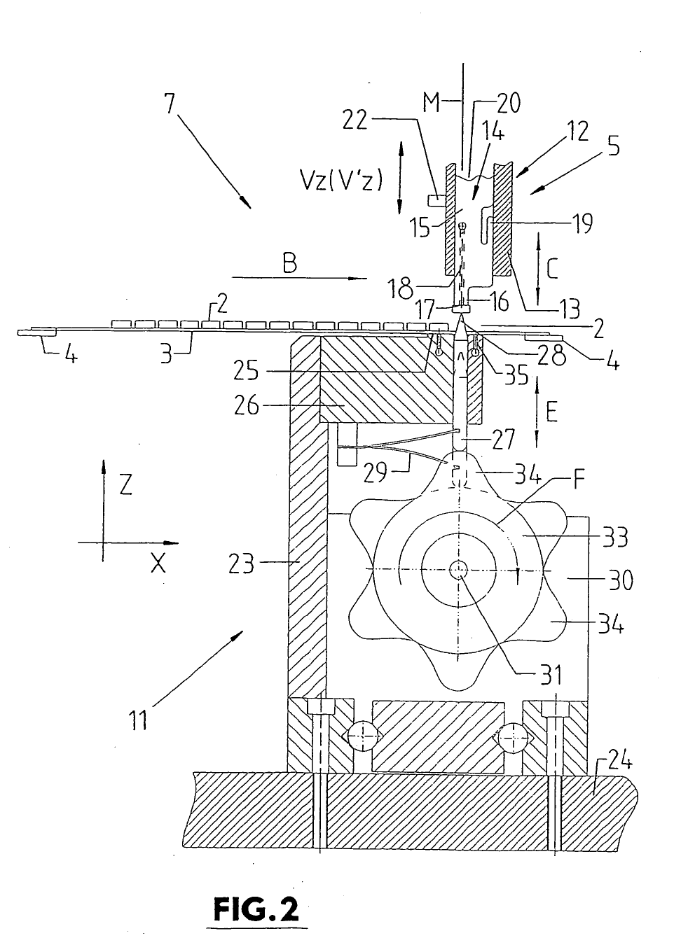

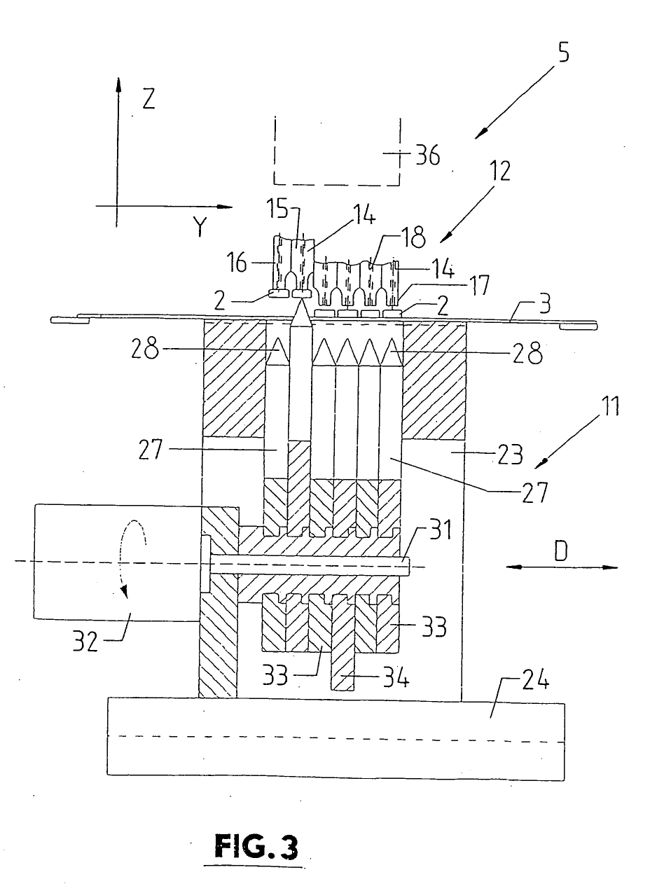

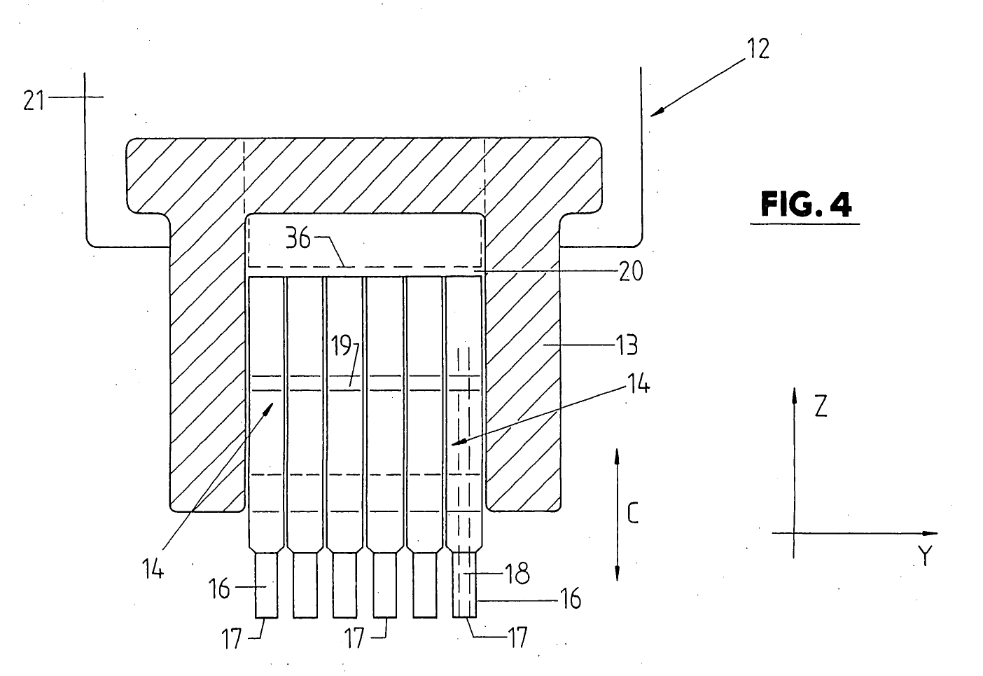

The work station 7 or the pick-up element 5 located there and a corresponding ram element 11, which is necessary for releasing the individual semiconductor chips 2 from the carrier foil 3 (self-adhesive foil or blue foil), are depicted in more detail in FIGS. 2 and 3.

The pick-up element 5 consists of a pick-up head 12 in which, or in the housing 13 of which, several vacuum holders 14 are present that can move in the direction of the Z-axis, namely with a limited stroke corresponding to the double arrow C.

The individual vacuum holders 14 have a lamellar design, i.e. they consist of a flat, plate-shaped body 15 with a rectangular form, which is located with its longer sides in the housing 13 parallel to the Z-axis and has a molded-on projection 16 on one lower narrow side, which (projection) with its free end forms a bearing surface 17 located in a plane parallel to the X-Y plane, at which a vacuum channel 18 opens.

On one long side the body 15 is shaped so that it forms a spring-mounted tongue 19 there, with which the vacuum holder 14 is supported on a surface of the guide 20 formed in the housing 13 for the body 15 of the vacuum holder 14.

The vacuum holders 14 are arranged with their bodies 15 adjoined in the form of lamellas in the opening or guide of the housing 13, namely so that the larger surface sides of the plate-shaped bodies 15 each are located in the X-Z plane. To move the pick-up head 12, it is fastened on a transport system 21, which comprises drives not further depicted, for example stepping motors for executing the controlled movements Hx, Hy, Vz, V′z.

On the pick-up head 12 there is also a vacuum connection, only generally indicated in the drawings as 22 and which is connected with a vacuum source not depicted for supplying the vacuum channels 14.

The ram unit 11 consists essentially of a housing 23, which can move, by means of a motorized drive not depicted and controlled by the electronic control unit 9, on a frame or base plate 24 of the work station 7 in the direction of the Y-axis by a pre-defined stroke D (FIG. 3). The top of the housing 23 forms a bearing or support surface 25 for the bottom of the carrier foil 3, namely on a housing section 26, in which several rams 27 that are tapered to a point at their top end and the axes of which are parallel to the Z-axis, can move axially in the direction of the Z-axis, namely for one movement stroke corresponding to the double arrow E of FIG. 2. The rams 27 are offset against each other in the direction of the Y-axis. The number of the rams 27 is the same as the number of the vacuum holders 14, i.e. one ram 27 is allocated to each vacuum holder 14. By spring means, which in the depicted embodiment are formed by leaf springs 29, each ram 27 is pre-tensioned in a lower position, in which the free end of the respective tip 28 is located beneath the support surface 25. On the housing 23 or on a board 30 located there, a shaft 31 can rotate on bearings on an axis parallel to the Y-axis, rotationally driven by a stepping motor and likewise controlled by the electronic control circuit 9 (arrow F of FIG. 2). On the shaft there are several cam plates 33, which are axially offset against each other and each of which forms a control cam 34. The axis of the shaft 31 is located in a Y-Z plane, in which also the axes of the rams 27 are located. Furthermore, the shaft 31 is located beneath the rams 27. A cam plate 33 is allocated to each ram 27, so that with each full revolution of the shaft 31, the respective ram 27 is moved by the control cam 34 located on the cam plate 33 from its starting position against the force of the spring element 29 upward into an upper stroke position, in which the respective ram 27 protrudes with its tip 28 through the carrier foil 4 clearly above the top of the carrier foil and above the level formed by the top of the wafer 1.

In the depicted embodiment, six cam plates 33 are provided for, corresponding to the number of rams 27. The control cams 34 of the individual cam plates 33 are offset at even angle distances on the axis of the shaft 31 so that when the shaft 31 is rotating, the rams 27 are moved upward from their starting position in temporal succession.

On the housing section 26 there is a ring groove 35 in the proximity of the bearing surface 25 surrounding the array of the rams 27, which (ring groove) is open on the bearing surface 25 and can be placed under controlled vacuum.

The special function of the work station 7 can be described as follows:

To remove a group 2′ of semiconductor chips 2, the carrier frame with the carrier frame holder is first moved in the forward feed direction B so that the row R1-Rn to be processed is located in the middle plane M of the ram 27. This plane is indicated in FIG. 2 as the middle plane M.

Afterwards, the pick-up head 12 is moved so that the vacuum holders 14 are located above the semiconductor chips 2 of the respective row R1-Rn to be picked up. The ram element 11 also is controlled by the electronic control unit 9 so that one ram 27 is located beneath one chip 2 respectively of the group 2′ to be picked up from the carrier foil 3. Afterwards, the pick-up head 12 is lowered vertically corresponding to the stroke Vz, whereby first each bearing surface 17 of each vacuum holder 14 comes to bear against one semiconductor chip 2 or its top side facing away from the carrier foil 3. The vacuum holders 14 are located thereby in the lower position of their stroke or sliding movement C relative to the housing 13. By means of the cam plates 33 located on the rotating shaft 31, the rams 27 are then moved upward and lowered again in succession. In each upward movement of a ram 27, the ram penetrates the carrier foil 3 with its tip 28, releases the corresponding semiconductor chip 2 from the carrier foil 3 and moves this semiconductor chip 2, which already bears against the bearing surface 17 and is held there by means of vacuum (vacuum channel 18), upward, whereby also the vacuum holder 14 in the guide 20 is pressed upward by means of the corresponding ram 27. By means of the spring-mounted tongue 19, the respective position of the vacuum holder 14 in the guide 20 is maintained, so that then during the subsequent downward movement of the respective ram 27, i.e. when the corresponding control cam 34 again releases the lower end of the ram 27, the corresponding semiconductor chip 2 is held on the bearing surface 17 of the vacuum holder 14 which has been pushed upward. In this way, all semiconductor chips 2 of the group 2′ to be removed are released in succession from the carrier foil 3 and moved together with the corresponding vacuum holder 14 into a position above the carrier foil 3. By means of the pick-up head 12, the semiconductor chips 2 held on the vacuum holders 14 are then moved as a group 2′ to the transport element 6 and then placed there after being lowered (vertical stroke V′z), corresponding to the rows R′1-R′n to be formed, as described above. During the return stroke of the pick-up head 12 for picking up a new group of semiconductor chips 2, i.e. before the initiation of the next work stroke, the vacuum holders 14 are moved back to their starting position by means of a slide 36 indicated in FIGS. 2 and 3 by a broken line. Due to the ring groove 35 that can be placed under vacuum, the carrier foil 3 is fixed to the bearing surface 25 during removal of the semiconductor chip 2, which significantly improves the removal of the semiconductor chip 2.

The fact that the raising of the rams 27 takes place in succession enables the efficient removal of each chip 2 from the self-adhesive carrier foil 3, namely due to the fact that the carrier foil 3 is deformed by the respective tip 28 before being penetrated, so that the carrier foil 3 hereby is completely released from the bottom of the respective semiconductor chip 2 and adheres to the latter only at the point of contact between the tip 28 and the bottom of the semiconductor chip 2.

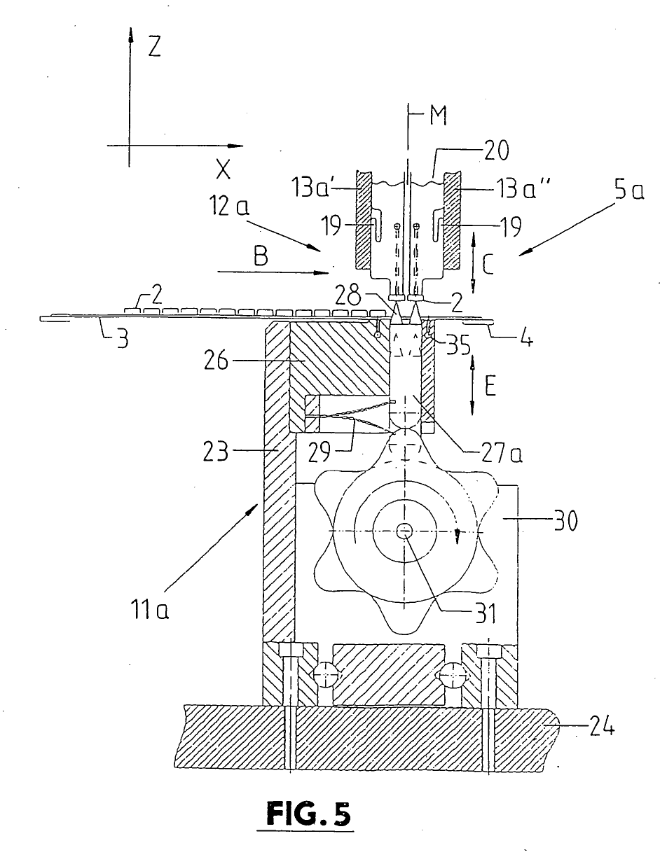

FIG. 5 shows in a depiction similar to FIG. 2 as a further possible embodiment a work station 7a, which differs from the work station 7 essentially only in that in each work stroke, semiconductor chips 2 of two adjacent rows R1-Rn are picked up as a group 2′ from the carrier foil 3. For this purpose, two rows of vacuum holders 14 are provided for on the pick-up head 12a of the pick-up element 5a, which corresponds in its function to the pick-up element 5, on both sides of the middle plane M, each of which can be movably guided in a housing 13a′ and 13a″ in the direction of the Z-axis. Each ram 27a corresponding to a ram 27 forms two tips 28. The distance between the axes of the vacuum holders 14 and their bearing surfaces 17 in the direction of the X-axis is the same as the distance between the axes of the two tips 28 in this X-axis and in the depicted embodiment is the same as the distance between the axes of two rows R1-Rn. The tips 28 are arranged in two rows extending in the direction of the Y-axis, namely such that upon removing the semiconductor chips 2 from the carrier foil 3, the axis of one tip 28 is congruent with each vacuum holder 4. The function of the work station 7a corresponds to the function of the work station 7, only with the difference that the semiconductor chips 2 of two adjacent rows R1-Rn are released in temporal succession from the carrier foil 3 and are lifted above the plane of the wafer 1 with the respective ram 27a held on the respective vacuum holder 2, i.e. the two adjacent semiconductor chips 2 of the two adjacent rows R1-Rn in the direction of the X-axis.

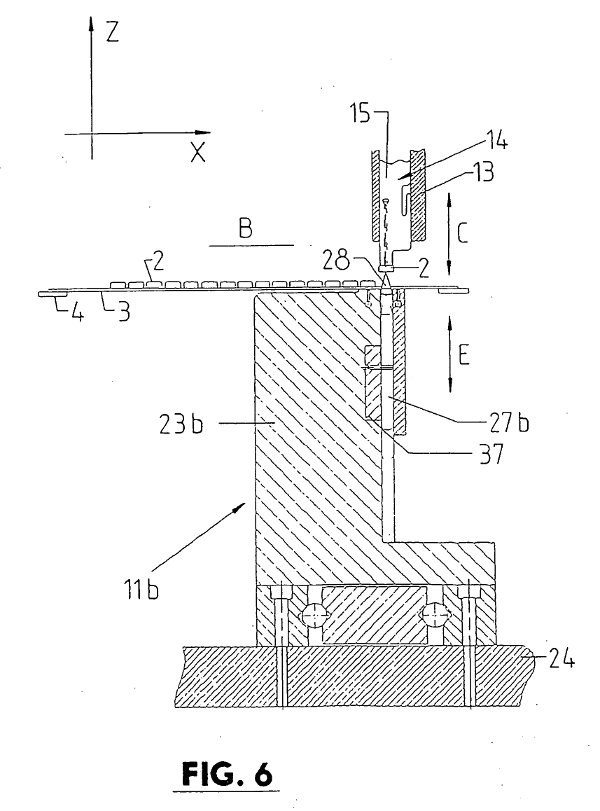

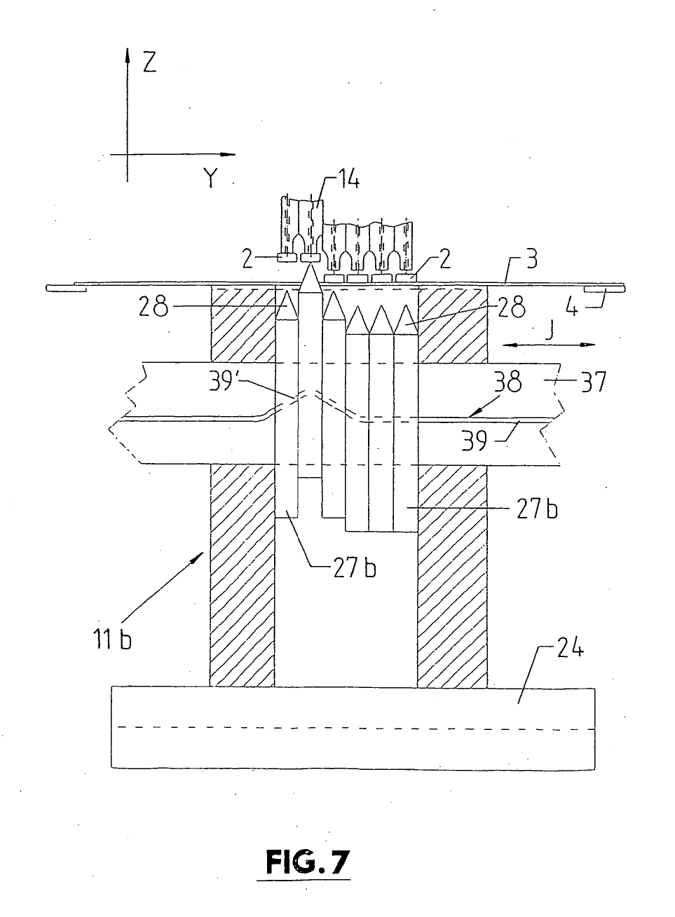

FIG. 6 shows as a further possible embodiment a work station 7b, which differs from the work station 7 only in that instead of the ram element 11, a ram element 11b is provided for. The latter likewise comprises a plurality of rams 27b on the housing 23b corresponding to the housing 23, which (rams) each form a tip 28 and can be moved axially, i.e. in the direction of the Z-axis, by the stroke E. The movement of the rams 27b is achieved by a control slide 37, which, mounted on bearings, can be moved back and forth in the housing 23b, in the direction of the Y-axis (double arrow I of FIG. 7), controlled by the electronic control unit 9. The slide 37 is provided with a control curve 38 of a groove 39, which extends over the majority of its length in the direction of the Y-axis and forms a section 39′, in which the control curve 38 rises diagonally in the direction of the Z-axis and then falls off again. A pusher 40 engages with each ram 27b in the control groove 39. With each full movement stroke of the control slide 37 in the one direction or the other direction, all rams 27b are moved in temporal succession one time from their starting position, in which the tips 28 are located below the plane of the carrier foil 3, into a raised position, in which the tips 28 have penetrated the carrier foil 3 and are located above the plane of the wafer 1, and then moved back into their starting position. In this embodiment, the control slide 37 with the control curve 38 replaces the cam plate 33 with the control cam 34. Otherwise, the function of the work station 7b corresponds to the function of the work station 7.

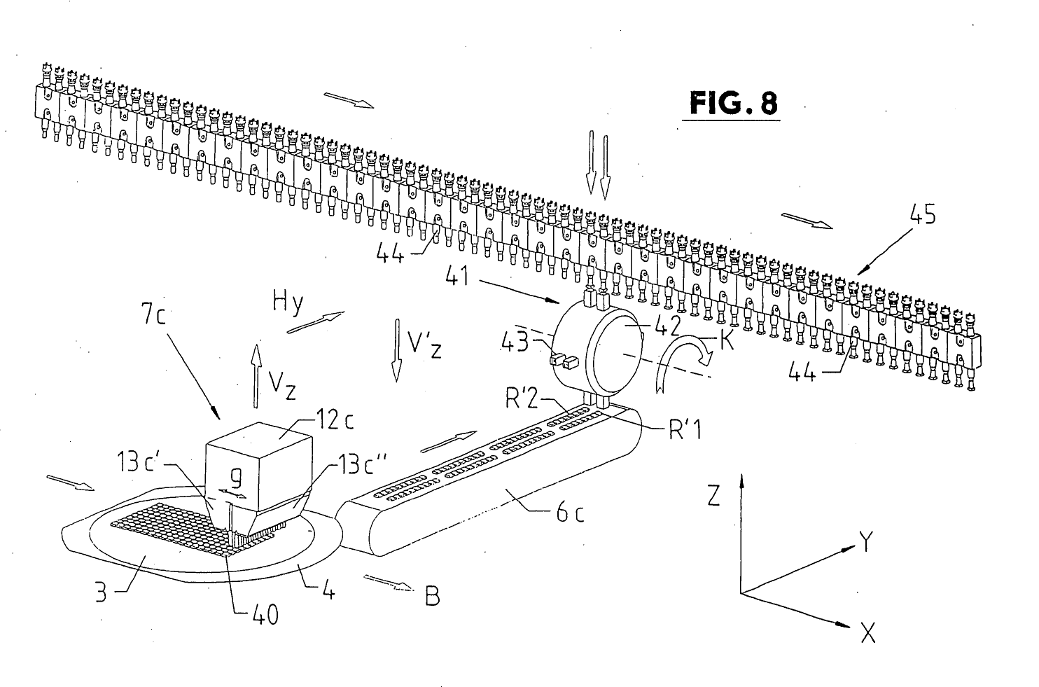

FIG. 8 shows in a simplified perspective representation a work station 7c, which is designed similar to the work station 7a, but in the depicted embodiment is used to process electrical components 40, which consist of a semiconductor chip enclosed in a plastic housing and are arranged on the carrier foil 3 in the carrier frame 4 in the same manner as the semiconductor chips 2, namely in a rectangular array with several rows and columns. By means of the work station 7c or the pick-up element 5c located there, in one work stroke, two rows of components 40 are picked up from the carrier foil 3 and placed in rows R′1, R′2 on a transport element 6, which is formed by a rotating transport belt. For this purpose, the pick-up head 12c of the pick-up element 5c comprises one row of vacuum holders 14 on each of two housings 13c′ and 13c″, which (vacuum holders) adjoin each other in each housing in the direction of the Y-axis. The two housings 13′ and 13″ can furthermore be moved relative to each other in the direction of the X-axis, namely by a pre-defined stroke, as indicated by the double arrow G. This not only makes it possible to pick up two rows of components 40 from the carrier foil 3 and place them on the transport element 6c in one work step, but also enables a distance between the rows R′1 and R′2 on the transport element 6c that is greater than the distance between the rows of components 40 on the carrier foil 3.

By means of a flipping station 41, which comprises groups of two vacuum holders each offset by 90° on a housing 42 that is driven rotationally in a pulsed cycle on the X-axis, the components 40 of the two rows R′1 and R′2 are transferred in succession to vacuum holders 44 of a transporter 45. For this purpose, the vacuum holders 43 can be controlled to move radially to the rotational axis of the housing 41 (X-axis), namely for the removal of the components 40 on the transport element 6c and for the transfer of two components respectively to the vacuum holders 44 of the transport element 45.

In FIG. 1, BL designates a reference line extending in the direction of the X-axis and thus perpendicular to the rows R1-Rn. The ends of the rows have differing distances from this reference line.

The invention was described above based on exemplary embodiments. It goes without saying that numerous modifications and variations are possible. It is possible, for example, to eliminate a vertical stroke Vz and/or V′z for the respective pick-up head 12, 12a, 12b for the pick-up elements 5, 5a, 5b and to achieve the corresponding vertical movement for the advance of the vacuum holders 14 to the chips 2 on the carrier foil 3 and for placing the chips 2 on the transport element 6 solely by moving the vacuum holders 14 within the respective pick-up head 12, 12a or 12b.

Furthermore, it is of course also possible to use the work stations 7, 7a and 7b for processing components 40 or, conversely, to use the work station 7c for processing semiconductor chips 2.

### REFERENCE SYMBOLS

1 wafer
2 semiconductor chip
2′ group of semiconductor chips
3 carrier foil
4 carrier frame
5, 5a, 5b, 5c pick-up element
6, 6c transport element
7, 7a, 7b, 7c work station
8 holder
9 electronic control unit
10 marking
11, 11a, 11b ram elements
12, 12a, 12b, 12c pick-up head
13, 13a′, 13a″, 13c′, 13c″ housing
14 vacuum holder
15 body
16 projection
17 bearing surface
18 vacuum channel
19 spring-mounted tongue
20 guide
21 transport or movement system
22 vacuum connection
23, 23b housing
24 frame
25 bearing surface
26 housing section
27, 27a, 27b ram
28 ram tip
29 spring
30 board
31 shaft
32 motor
33 cam plate
34 control cam
35 ring groove
36 reset slide
37 control slide
38 control curve
39 control groove
39′ control groove section
40 component
41 flipping station
42 housing
43 vacuum holder
44 vacuum holder
45 transport element
X, Y, Z spatial axis
A transport direction
B forward feed
C, D, E movement stroke
F direction of rotation
G movement stroke
Hx, Hy horizontal stroke
Vz, V′z vertical stroke
I movement stroke
K direction of rotation
R1, Rn row
R′1, R′n row
M middle plane

1-51. (canceled)

52. A device for processing electrical components, which are releasably held on a first carrier formed by a carrier foil in an array forming a plurality of first rows (R1-Rn), whereby at least some of the first rows (R1-Rn) contain at least two components and whereby the components are each picked up by at least one pick-up element from the carrier foil and placed on a second carrier and in each work stroke one group of the at least two components is picked up from the carrier foil with the at least one pick-up element and placed on the second carrier, wherein the at least one pick-up element comprises a pick-up head with a plurality of vacuum holders, which can be movably guided individually in a first axis direction perpendicular to the plane of the carrier foil, and that a plurality of needles or pins is provided, which for releasing the electrical components from the carrier foil can be moved axially and in temporal succession in the first axis direction from a starting position distanced from the side of the carrier foil facing away from the electrical components against this side of the carrier foil, so that by means of the respective needle or pin a electrical component is released from the carrier foil and moved away from the carrier foil together with the vacuum holder holding this component.

53. A device for processing electrical components, which are releasably held on a first carrier formed by a carrier foil in an array forming a plurality of first rows (R1-Rn), whereby at least some of the first rows (R1-Rn) contain at least two components and whereby the components are each picked up by at least one pick-up element from the carrier foil and placed on a second carrier, whereby the at least one pick-up element with which in each work stroke a group of at least two components is simultaneously picked up from the carrier foil and placed on the second carrier.

54. The device according to claim 52, wherein the vacuum holders are lamellar-shaped and adjoining vacuum holders.

55. The device according to claim 52, wherein the at least two components are semiconductor chips and that the array of components on the carrier foil is a semiconductor wafer separated into the semiconductor chips.

56. The device according to claim 52, wherein the at least two components are electrical components, preferably semiconductor components provided with an extruded housing.

57. The device according to claim 52, wherein the at least two components are placed on the second carrier so that they form at least one row on said carrier, in which (row) the components adjoin each other in a first axis direction (Y-axis).

58. The device according to claim 52, wherein the first rows (R1-Rn) on the carrier foil (3) are each oriented in a common first axis direction (Y) or in a second axis direction (X-axis) extending perpendicular to the first axis direction.

59. The device according to claim 52, wherein the first rows (R1-Rn) on the carrier foil have different lengths.

60. The device according to claim 52, wherein the first rows (R1-Rn) at least partially display varying distances from their beginning and/or end from a reference line (BL) that is common to all first rows (R1-Rn) and extends perpendicular to the longitudinal extension of these rows.

61. The device according to claim 52, wherein for the formation of the at least one second row (R′1-R′n) on the second carrier, a pick-up head, for picking up the respective group of components from the carrier foil and for placing this group of components on the second carrier, is controlled by an electronic control unit so that it executes a different movement stroke (Hx, Hy), namely based on the position and/or number of the components respectively picked up from the carrier foil.

62. The device according to claim 61, wherein the pick-up head is controlled by the electric control unit so that the components are picked up from the carrier foil by rows, and corresponding to the first rows (R1-Rn).

63. The device according to claim 61, wherein the pick-up head is controlled by the electric control unit so that for each work stroke of the pick-up element, only components from a first row (R1-Rn) are picked up from the carrier foil.

64. The device according to claim 61, wherein the pick-up head is controlled by the electric control unit so that for each work stroke, components from two first rows (R1-Rn) are picked up from the carrier foil and placed on the second carrier.

65. The device according to claim 52, further comprising a drive for a forward feed (B) for the carrier foil in an axis direction extending perpendicular to the longitudinal extension of the first rows (R1-Rn), for example in the second axis direction (X-axis).

66. The device according to claim 61, wherein for the formation of at least two second rows (R′1-R′n), the pick-up element is also movable at least in one axis direction (X-axis) crosswise to the longitudinal extension of the at least two second rows (R′1-R′n).

67. The device according to claim 52, further comprising a pick-up element, which comprises at least two fixtures in at least one row for one component each.

68. The device according to claim 52, further comprising a pick-up element, which comprises at least two rows with at least two fixtures each for one component each.

69. The device according to claim 68, wherein the at least two fixtures are formed by bearing surfaces of a multiple vacuum holder.

70. The device according to claim 52, further comprising a pick-up element with at least one pick-up head made as a multiple vacuum holder.

71. The device according to claim 69, wherein the pick-up element has a pick-up head which comprises a plurality of lamellar-shaped and adjoining vacuum holders, which preferably can be moved in a housing in one axis direction, in a third axis direction perpendicular to the plane of the carrier foil and/or to the plane of the second carrier.

72. The device according to claim 52, further comprising means for releasing the at least two components from the carrier foil.

73. The device according to claim 72, wherein the means for releasing are needles or rams, with which the components are released by puncturing the carrier foil from the side of this carrier foil facing away from the components and secured on the pick-up element during the release.

74. The device according to claim 73, wherein the release of the components in each group of components from the carrier foil takes place in temporal succession.

75. The device according to claim 52, wherein the second carrier is formed by the transport surface of a transport element.

76. The device according to claim 52, further comprising a ram element, in which several rams or pins present in a housing or housing section are axially movable and can be moved by a control unit from a non-effective starting position into a position releasing the components from the carrier foil.

77. The device according to claim 76, wherein the control means are formed by control cams and/or by a control curve.

78. The device according to claim 52, wherein the at least two components are picked up by means of a flipping station in the second carrier and fed to a further processing unit, for example to a further transport element or fixtures located there.
